(19) United States
(12) Patent Application Publication
(10) Pub. No.: US 2015/0140162 A1
(43) Pub. Date: May 21, 2015

(54) MICROWAVE RICE COOKING BOWL

(71) Applicant: Christopher Johnson, Wilton, CA (US)

(72) Inventor: Christopher Johnson, Wilton, CA (US)

(21) Appl. No.: 14/517,462

(22) Filed: Oct. 17, 2014

Related U.S. Application Data
(60) Provisional application No. 61/892,877, filed on Oct. 18, 2013.

(51) Int. Cl. A47J 36/02; A23L 1/10

(52) U.S. Cl. CPC A47J 36/027; A23L 1/1033; A23V 2002/00
USPC 426/2; 219/731; 426/508

(57) ABSTRACT

A bowl is provided for rapid and repeatable high quality cooking of rice or other grains within a microwave. The bowl includes a reservoir with a floor and walls extending up from the floor to a rim. Handles are preferably provided extending laterally from the rim. A rice line is provided which is visible to a user and defines a height at which rice should be added for cooking within the bowl. A water line is provided above the rice line which defines an elevation to which water should be added for cooking of the rice. In one embodiment walls of the reservoir are tapered to accommodate boiling and frothing without boiling over and still maintaining a compact cooking space within the bowl.

### CROSS-REFERENCE TO RELATED APPLICATIONS

This application claims benefit under Title 35, United States Code §119(e) of U.S. Provisional Application No. 61/892,877 filed on Oct. 18, 2013.

### FIELD OF THE INVENTION

The following invention relates to cookware for cooking of rice and similar grains by heating the rice within a water bath. More particularly, this invention relates to rice cooking containers which facilitate cooking of rice in a microwave oven.

### BACKGROUND OF THE INVENTION

Rice is most typically cooked in a specialty appliance referred to as a rice cooker or on a stovetop. The stovetop method involves locating an appropriately sized pan or other container, placing an amount of rice to be cooked within the pan, adding water into the pan and placing the pan on a cooktop and applying heat until the rice is cooked and has absorbed substantially all of the water.

While seemingly straightforward, this rice cooking process utilizing the pan method has multiple opportunities for serious error. For instance, the correct ratio of rice to water must be very precise. If the user supplies too little water, the rice will not be fully cooked before it begins to burn. If too much water is supplied, the rice will be fully cooked but still “soupy” with residual water contained in the pan with the rice. While the rice can be cooked longer to absorb this excess water, the rice will break down and become “mushy” due to the excess cooking

Furthermore, the shape of the pan, whether the pan is covered or not, the type of cooktop, and even the type of rice (or other grain) are all factors which must be accounted for in properly providing the right amount of water for the amount of rice to be cooked. Also, the ratio of water to rice is not necessarily constant, but can vary somewhat whether a smaller amount of rice or larger amount of rice is being cooked, depending on the shape of the pan, whether it has a lid or not, and other factors.

Even if the correct amount of water is supplied with the rice, it can be difficult to cook the rice for the proper amount of time. One can watch the pot of rice being cooked very carefully but it is difficult to see when rice at a lower portion of the pan is beginning to burn, and when all of the water has been absorbed into the rice. Without tasting or otherwise testing a sample of the rice, it can be difficult to determine if the rice has been fully cooked or not. Hence, a cook who is cooking rice, especially when a novice, must carefully attend to the rice cooking pan and cannot easily multi-task with other cooking activities while the rice is cooking

Another disadvantage of the process of cooking rice in a pan is that when the rice has been cooked it typically has been cooked somewhat unevenly based on whether the rice is close to a floor of the pan or further from this lower surface of the pan. Also, the surfaces of the pan will often have at least some amount of rice stuck quite tenaciously to surfaces of the pan so that such rice is typically wasted, and also creates significant complexity and effort for the pan cleanup procedure. Such pan cleaning is made difficult even when the rice is cooked a proper amount without burning If the rice is burned, this cleaning procedure is made much more complex and time consuming

Rice cookers solve some but not all of these difficulties in what should be the simple process of cooking a quality serving of rice. When utilizing a rice cooker, the same method as with cooking rice in a pan is followed, except using a container of the rice cooker. The rice cooker supplies its own heat source so that the rice does not need to rest upon a cooktop. Also, the rice cooker has a sensor which detects when the rice has been cooked a proper amount and turns off the heat source within the rice cooker. One still has the complexity of supplying the proper amount of rice and water and the difficulty of cleaning.

Also, requiring a separate electric appliance means that additional counter space must be devoted to the rice cooker as well as storage space for the rice cooker when not in use. The various electronics within the rice cooker are more efficiently utilized when the rice cooker is a larger rice cooker supplying multiple servings of rice. However, often the individual desires to enjoy a meal including rice and only needs one serving of rice. Even when more than one serving of rice is desired, but only a small number (four or less) servings, rice cookers either are ineffective at making such small batches of rice or decrease the efficiency of the overall process because a relatively complex machine is required for a relatively small number of servings. Finally, cleanup of the rice cooker adds complexity to the process.

Even when rice is perfectly cooked in a pan or with the rice cooker, before the rice can be enjoyed, the user typically transfers the rice to a separate serving appliance, such as a plate or bowl. A serving utensil is typically utilized which then must also be later washed. Leftover rice which was not utilized in the meal must either be disposed of or transferred to a storage container for placement in a refrigerator or otherwise storing for later consumption. A user will then typically also add other ingredients to the rice before enjoying.

A need is particularly acute for individuals and small groups, and especially those in cooking environments with limited space, to simplify the rice cooking process to provide quality rice in a repeatable fashion, and utilizing as little space and as little equipment as possible. Such circumstances might include individuals living in studio apartments or other small locations, or students (and others) in dormitories, or other individuals living in tight quarters (i.e. aboard a ship) or with limited resources. Such small environments almost always include a microwave oven therein, such that a need exists to utilize the microwave oven in the cooking of a single serving or a small number of servings of rice in a manner which minimizes equipment required and amount of cleanup before the rice can be effectively enjoyed.

### SUMMARY OF THE INVENTION

With this invention a rice cooking bowl is provided suitable for use in a microwave oven, which product doubles as both a cooking bowl and also a bowl from which the rice can be enjoyed for consumption. The bowl is configured to function as a measuring device initially for measuring quantities of rice and water to be utilized in a cooking process. The bowl then functions as a cooking container for holding the rice during cooking thereof in a microwave oven. The cooking bowl has a shape which facilitates even and high quality cooking of the rice in a rapid fashion utilizing the microwave energy supplied by the microwave oven. The cooking bowl also preferably includes handles which are heat resistant, at least due to their geometry, to enable the cooking bowl to be easily removed from the microwave when containing the cooked rice therein.

The bowl includes a reservoir defined by a floor on a lower surface and with at least one wall extending up from the floor to a rim. This wall could be circular or oval, or could be more square or rectangular or some other geometric shape with generally planar sides joining together to surround the reservoir between the floor and the rim. In the embodiments depicted herein, the reservoir has a somewhat oval shape with a pair of side walls spaced from each other and a pair of end walls spaced from each other and interposed between two of the side walls. Side walls and end walls transition together through lateral curves which give the reservoir a somewhat oval shape. Lower curves are preferably provided transitioning between the floor and the at least one wall. Such curves make it easier for a user to enjoy all of the rice within the container and to have an easier cleanup process after the bowl has completed its use.

Handles are preferably provided, such as with a pair of handles extending from each end wall adjacent the rim in embodiments such as those depicted herein. The handles preferably extend from the rim to a tip with an arch on an upper surface and a cove on a lower surface. The convex arch on the upper surface keeps hot water from pooling on the handles which might otherwise injure a user. The cove on the lower surface acts as a convenient purchase area for fingers of a user to rest under the handles and easily move the bowl out of the microwave and otherwise move the bowl where desired.

The bowl includes a visible rice line and a visible water line thereon. The rice line is visible to a user and defines a level up to which rice should be placed into the bowl for cooking The water line is provided above the rice line and defines a line up to which water should next be supplied when the rice is to be cooked. The rice line and water line are located precisely where desired for optimal cooking of the rice. The rice line and water line can be mere visual markings, such as those printed on an inside surface of at least one of the walls. The lines could be geometrically formed into at least one of the walls, such as by providing a step, a groove or a bump at the line location which can be visually perceived by a user.

The at least one wall extends up from the floor to the rim in a direction which is tapered away from perpendicular from the floor by a taper angle away from vertical, and causing the rim to be wider than the floor. A taper angle for this taper is most preferably about 10°, but provides benefit to the invention when at least 5°.

The extraordinarily simple method of cooking rice with the microwave rice cooking bowl of this invention merely includes filling the reservoir with rice up to the rice line, filling the reservoir with water up to the water line, placing the bowl with rice and water into the microwave, and operating the microwave for a preferred amount of cooking time. When the time has elapsed, the rice is ready to enjoy directly from the bowl, typically by adding other ingredients to the rice directly within the bowl and then enjoying the rice and other ingredients directly from the bowl, utilizing the bowl as a serving dish.

### OBJECTS OF THE INVENTION

Accordingly, a primary object of the present invention is to provide a bowl for cooking rice in a microwave.

Another object of the present invention is to provide a rice cooking method which is faster than previous methods.

Another object of the present invention is to provide a rice cooking bowl which can cook rice without requiring a specialty electronic appliance other than a microwave.

Another object of the present invention is to provide a rice cooking bowl which repeatedly provides perfect rice every time it is used.

Another object of the present invention is to provide a rice cooking bowl which can cook at least one serving of rice or other grains quickly.

Another object of the present invention is to provide a rice cooking bowl which can both cook rice and act as a serving container for serving the rice.

Another object of the present invention is to provide a rice cooking bowl which cooks rice in amounts as small as a single serving.

Another object of the present invention is to provide a method for cooking and enjoying rice which has a minimum of cleanup and requires a minimum amount of cooking space and cooking equipment.

Another object of the present invention is to provide a rice cooking method which is simple to perform without requiring specialty tools such as measuring cups.

Another object of the present invention is to provide a rice cooking method which is resistant to problems such as burning the rice, overcooking the rice, undercooking the rice or “soupy” rice.

Other further objects of the present invention will become apparent from a careful reading of the included drawing figures, the claims and detailed description of the invention.

### BRIEF DESCRIPTION OF THE DRAWINGS

FIG. 1 is a perspective view of the rice cooking bowl of this invention according to a first embodiment.

FIG. 2 is a top plan view of that which is shown in FIG. 1.

FIG. 3 is an end elevation view of that which is shown in FIG. 1.

FIG. 4 is a side elevation view of that which is shown in FIG. 1.

FIG. 5 is a perspective view of that which is shown in FIG. 1 after a first step of adding rice to the reservoir of the bowl.

FIG. 6 is a perspective view of that which is shown in FIG. 5 after water has been further added to the bowl.

FIG. 7 is a side elevation full sectional view of that which is shown in FIG. 6.

FIG. 8 is a view similar to FIG. 7 except after the rice and water have been cooked to provide a serving of cooked rice within the bowl.

FIGS. 9-12 are views similar to FIGS. 1-4 but for an alternative embodiment bowl having a greater taper angle for the walls.

### DESCRIPTION OF THE PREFERRED EMBODIMENT

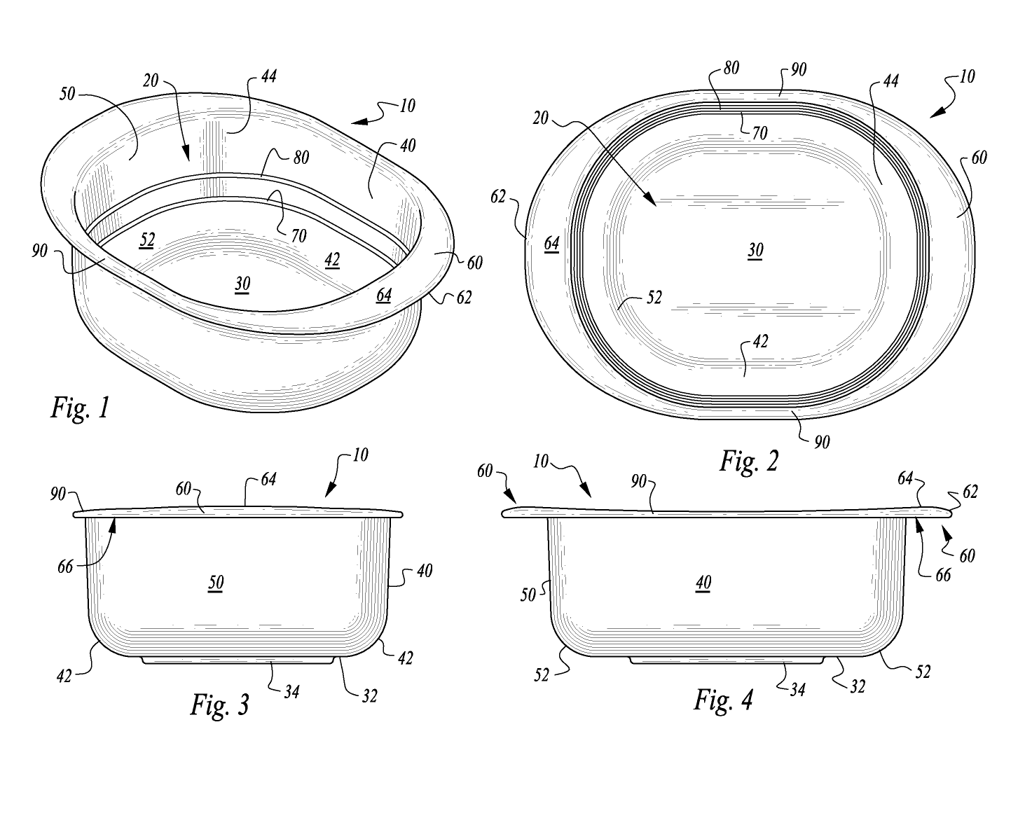

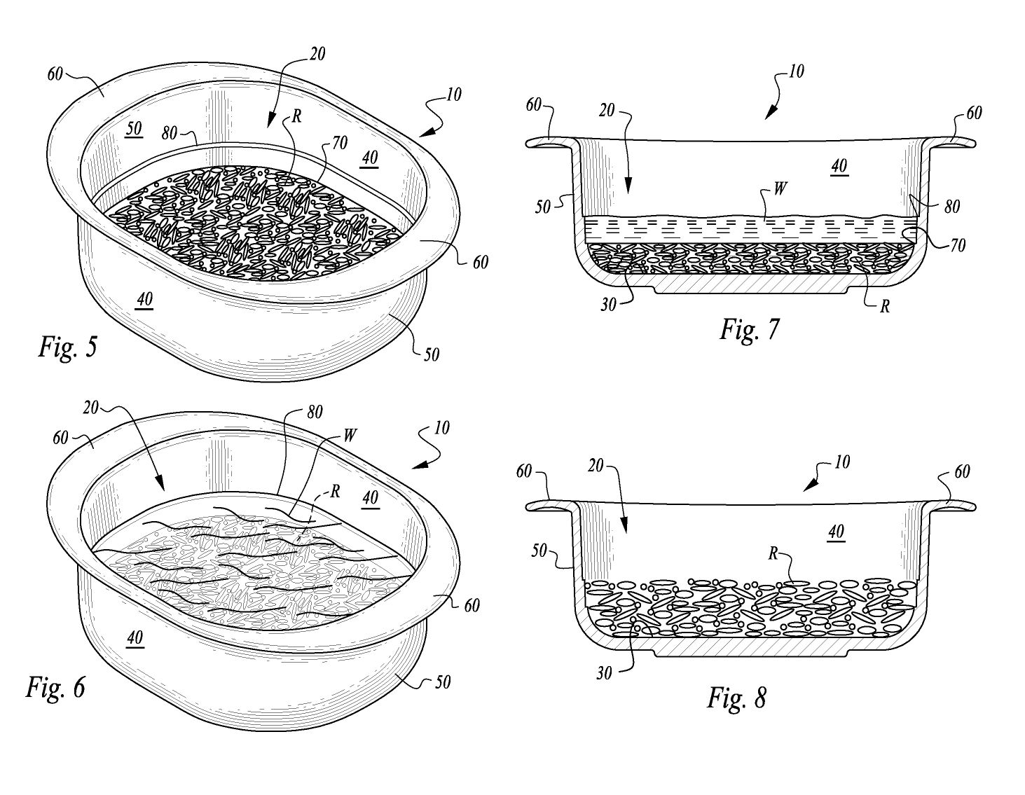

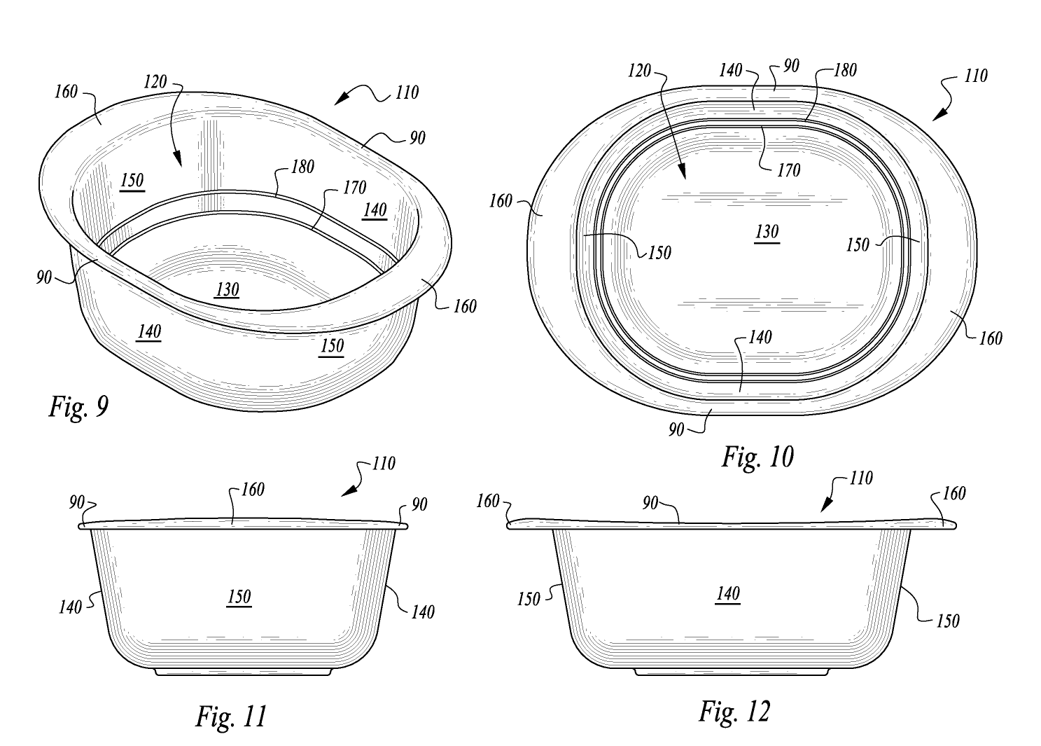

Referring to the drawings, wherein like reference numerals represent like parts throughout the various drawing figures, reference numeral 10 is directed to a bowl (FIG. 1) for cooking rice or other grains in a microwave oven. The bowl 10 greatly simplifies the process of cooking rice R and provides high quality cooked rice in a repeatable fashion while also simplifying the serving, enjoying and cleanup processes associated with enjoying a serving of rice.

In essence, and with particular reference to FIGS. 1-4 and 8-11, basic details of this invention are described, according to two exemplary embodiments. The bowl 10 includes a reservoir 20. The reservoir 20 is defined by a floor 30 on a lower end thereof and at least one wall extending up from the floor 30 to a rim 90. Most preferably the at least one wall is in the form of a pair of side walls 40 opposite each other and a pair of end walls 50 opposite each other and interposed between each of the side walls 40. Handles 60 extend laterally from the rim 90, defining an upper end of the side walls 40 and end walls 50 opposite the floor 30. Preferably two such handles 60 are provided extending from each of the end walls 50. A rice line 70 is visible on at least one of the walls spaced from the floor a distance defining an amount of rice R to be placed into the bowl 10. A water line 80 is visibly apparent above the rice line 70 and defining a level to which water W should be placed into the reservoir 20 for cooking of the rice R. In the tapered bowl 110 (FIGS. 9-12) side walls 140 and end walls 150 are provided with a significant taper away from perpendicular to a floor 130, such as with a taper angle away from perpendicular to the floor 130 of most preferably 10°, causing a rim 190 to be wider than the floor 130.

More specifically, and with continuing reference to FIGS. 1-4, structural details of the reservoir 20 are described, according to a first embodiment. The reservoir 20 is an open topped container defining a volume of space bounded on a lower side by the floor 30 and on lateral sides by at least one wall, and in this embodiment a pair of side walls 40 and a pair of end walls 50. The reservoir 20 defines a volume of sufficient size to contain at least one serving of rice R before cooking, as well as an amount of water W suitable for cooking the rice R. The reservoir 20 also has additional space to facilitate containment of the water W and rice R as the rice R expands during cooking, and to keep the water W within the reservoir 20 when the water W is boiling, frothing or otherwise dynamically moving within the reservoir 20, to avoid spillage.

Most preferably, the floor 30, side walls 40 and end walls 50 are formed together as a unitary mass of rigid injection moldable plastic material. A plastic material is selected which is capable of forming by molding, and which also is resistant to melting, outgassing or other alterations when experiencing the microwave energy present within a microwave oven and when experiencing typical heat ranges associated with boiling of water W and cooking of food within a microwave oven. One such suitable plastic material includes polypropylene. Others include high density polyethylene and polyethylene terephthalate.

The floor 30 is preferably planar and is typically oriented horizontally when the bowl 10 is resting on a horizontal surface. The floor 30 includes an undersurface 32 facing downward with a foot 34 preferably extending downwardly therefrom. This foot 34 could be a single structure or multiple structures which hold the undersurface 32 slightly up off of a planar underlying surface and provide the bowl 10 with a stable platform when resting upon such a horizontal underlying surface. The undersurface 32 also provides a location where cooking information can conveniently be embossed directly into the plastic forming the bowl 10 or otherwise placed, such as on an adhesive label. In the embodiment depicted, the foot 34 is in the form of a circuit of material extending slightly lower than other portions of the undersurface 32 and slightly inboard of a perimeter of the floor 30.

While the bowl 10 is preferably formed of an injection moldable plastic material, the bowl 10 could be formed from other materials suitable for the heat and microwave energy environment within a microwave oven, and also suitable for coming into direct contact with food items. Such alternative materials could include glass, ceramics, wood and other cellulosic materials, and various different hydrocarbon solid materials known to exist or developed in the future.

At least one wall extends up from the floor 30 to the rim 90. In one embodiment this at least one wall could be a circular wall or an oval wall which completely surrounds the floor 30 and provides lateral containment for the reservoir 20. In the embodiment depicted herein, this at least one wall is configured as a pair of side walls 40 and a pair of end walls 50. The pair of side walls 40 are provided opposite each other and are wider than the end walls 50. The end walls 50 are also provided as a pair with one end wall 50 interposed between the side walls 40 at one end of the reservoir 20 and the other end wall 50 provided between the pair of side walls 40 at the other end of the reservoir 20.

Lateral curves 44 join the side walls 40 to adjacent end walls 50. These lateral curves 44 preferably exhibit a constant radius of curvature to avoid a sharp interior corner as these lateral curves 44 transition between adjacent walls 40, 50. The side walls 40 have lower curves 42 which provide a gradual transition between the substantially horizontal floor 30 and the substantially vertical side walls 40. This lower curve 42 preferably has a constant radius of curvature which is preferably less than a radius of curvature of the lateral curves 44. The lower curves 42 avoid a sharp interior corner at the transition between the side walls 40 and the floor 30 within the reservoir 20.

At junctions of the lower curves 42 and the lateral curves 44, a somewhat toroidal curving section is provided, further avoiding sharp interior corners within the reservoir 20, such as to avoid any spots which would be difficult to clean. The end walls 50 also preferably include lower curves 42 at lower ends of the end walls 50 where the end walls 50 transition into the floor 30. The lower curves 52 on the end walls 50 are preferably similar to the lower curves 42 on the lower ends of the side walls 40.

With continuing reference to FIGS. 1-4, details of the handles 60 are described, according to the exemplary embodiment depicted therein. The handles 60 are preferably provided as a pair extending from upper ends of each of the end walls 50 adjacent the rim 90. As an alternative, the handles 60 could extend from the side walls 40 or from corners between the end walls 50 and side walls 40. If the bowl 10 has a more cylindrical form with a single circular side wall, the handles 60 would merely extend from two generally opposite locations at the rim 90 of such a wall.

The handles 60 preferably extent substantially horizontally laterally away from each other and away from the reservoir 20. The handles 60 extend to a tip 62 which is a free tip allowing a user to easily place fingers beneath the handles 60 to elevate the entire bowl 10, such as to remove the bowl 10 from a microwave oven after cooking Because the handles 60 are generally thin and only attach to the bowl 10 at an end of the handles 60 opposite the tip 62, the handles 60 will have a lower temperature than other portions of the bowl 10 due to conduction heat transfer from the cooking rice R. The handles 60 can thus more readily be held than other portions of the bowl 10.

To further facilitate handling of the handles 60 and the entire bowl 10, the handles 60 preferably have a slightly non-planar contour. In particular, an upper surface of the handles 60 preferably is formed of an arch 64 being convex. A lower surface of the handles 60 is preferably provided as a cove 66 which is concave in form. By providing the upper surface as the convex arch 64, water cannot pool on the handles 60. This feature keeps very hot water from resting on the handles 60 and potentially presenting a burn hazard to users. The cove 66 provides a convenient location for fingers to be located and to more securely grasp the handles 60 without slipping out of the hands of the user. The arch 64 and cove 66 preferably have similar radii of curvature so that the thickness of the handles 60 remain substantially constant between the arch 64 and cove 66 as the handles 60 extend to the tip 62.

With continuing reference to FIGS. 1-4, details of the rice line 70 and water line 80 are described, according to this exemplary embodiment. A series of lines are provided on the reservoir 20 of the bowl 10 to indicate where rice R (or other grains) should be located to provide the proper amount of rice R, and how much water W should be located within the reservoir 20. A first line closest to the floor 30 is referred to as the rice line 70. The rice line 70 defines a level to which uncooked rice R should be placed within the reservoir 20 when utilizing the bowl 10. Similarly, the water line 80 is above the rice line 70 and defines a level to which water W should be placed into the reservoir 20 of the bowl 10 for cooking of the rice R that has been placed up to the rice line 70. In an exemplary embodiment, the rice line 70 is at a common elevation with an upper end of the lower curve 42, 52 between the floor 30 and the walls including the side walls 40 and end walls 50. Alternatively, this rice line 70 could be at some other location spaced from this transition. One exemplary dimension for the rice line 70 is 0.625 inches above the floor 30 and exhibits generally effective results when between 0.5 inches and 0.75 inches. In terms of rice R amount, about five ounces of rice are placed in the bowl 10.

The water line 80 is above the rice line 70 and defines a level to which water W should be placed within the reservoir 20 of the bowl 10. The actual water W provided when filled up to the water line 80 includes this space between the rice line 70 and the water line 80 as well as space between individual grains of rice (or other grains) filling the reservoir 20 up to the rice line 70. The level of the water line 80 is carefully selected partially based on the typical geometry of grains of rice R and the amount of open space between grains of rice R when typically resting within the reservoir 20. Thus, a proper amount of water W is provided when the water W is placed within the reservoir 20 up to the water line 80 after rice R has already been placed into the reservoir 20 up to the rice line 70. A distance between the water line 80 and the floor 30 is typically preferably 0.75 inches and exhibits generally effective results when between about 0.625 and 0.875 inches above the floor 30. In terms of water W amount, about eight ounces of water W are placed in the bowl 10. The rim 90 is spaced above the water line 80 by a height sufficient to avoid boiling over of water during the cooking process. One typical useful dimension for the rim 90 is to be at least about 1.50 inches above the floor 30.

The rice line 70 and water line 80 can be formed in a variety of different ways to be visually perceptible. In the embodiment depicted, the rice line 70 and water line 80 are each provided as steps in the interior surface of the walls including both the side walls 40 and end walls 50. These steps define transitions between a slightly lesser width between the walls below the steps and a slightly greater width between the walls above the steps. As an alternative, the rice line 70 and water line 80 could be geometric forms other than steps, such as the form of a groove cut into the walls or a bump extending out of the walls. The rice line 70 and/or water line 80 could also alternatively be a non-geometric feature, such as in the form of a printed line on the surface of the walls.

The walls extend up from the floor 30, preferably substantially vertically, but typically with a slight draft thereto. This slight taper in the embodiment of FIGS. 1-4 is about 2° or less and is just sufficient to allow injection molded bowls 10 to more conveniently pop out of a mold after forming, and to facilitate stacking of multiple bowls 10 in an efficient manner somewhat nested into each other.

Most preferably, and with reference to FIGS. 9-12, the bowl 10 is provided as a tapered bowl 110 which has a greater taper between the floor 130 and the rim 190. The reservoir 120 in such a tapered bowl 110 thus has a pronounced greater width adjacent the rim 190 than at the floor 130. Other features of the tapered bowl 110 are similar to those of the bowl 10, including side walls 140 and end walls 150 (or alternatively merely at least one wall such as for a circular alternative). The tapered bowl 110 also features handles 160 extending laterally from upper ends of the end walls 150 or otherwise from the rim 190 of the tapered bowl 110.

The tapered bowl 110 has a taper angle greater than that of the bowl 10 and most preferably measuring 10° away from perpendicular to the floor 130. Such a taper angle causes the rim 190 to be significantly wider than the floor 130. This additional width at the rim 190 is important in that as water is boiling within the reservoir 120, the water/steam has a tendency to rise in the form of bubbles or in the form of a “rapid boil” or other dynamic effects which can elevate liquids up within the reservoir 120 to near or over the rim 190. If water/steam spills out of the reservoir 120, it is no longer absorbed by the rice R as part of the cooking process, leaving the rice R somewhat under-hydrated. Also, a mess is created within the microwave which requires cleanup. By having the walls taper up from the floor 130 to the rim 190, this greater width adjacent the rim 190 tends to cause any such bubbles or rapid boil to have more room and to decrease its ability to elevate above the rim 190 for potential spillage. If a foamy frothy effect tends to rise within the reservoir 120 during cooking, the greater width adjacent the rim 190 causes this rising foam to reach a static elevation below the rim 190, rather than creeping up over the rim 190.

Experimentation has shown that 10° is an optimal angle to avoid spillage of water W from the reservoir 120, while still maintaining a compact mass of rice R and water W for effective heating without hot spots or other non-uniform heating within the bowl 110. To some extent the benefits of this taper can still be achieved when the taper angle is as low as 5°, while 10° is considered optimal.

In use and operation, and with particular reference to FIGS. 5-7, details in the operation of the method of this invention are described, according to a preferred embodiment. Initially, and as depicted in FIG. 5, rice R is placed into the reservoir 20 of the bowl 10 up to an elevation matching that of the rice line 70. Water W is then added into the reservoir 20 up to the water line 80 (FIGS. 6 and 7). This water W not only wets the rice R below the rice line 70, but also fills a space between the rice line 70 and water line 80.

The bowl 10 is then placed within a microwave and the microwave is turned on. The microwave is run for a period of time appropriate for cooking of the rice R. This cooking time can vary depending on the power of the microwave and whether the rice is unmodified rice grains or whether the rice has been pre-cooked or otherwise altered, such as by pre-cooking and dehydration, to make the rice cook more quickly. In a preferred form of this invention, the water line 80 and rice line 70 are each selected and optimized for the cooking of such “quick rice” which has been previously cooked and dehydrated. As an alternative, the bowl 10 can be configured with a rice line 70 and a water line 80 which are optimized for unmodified rice R grains. Also, the bowl 10 could be modified by placement of the lines 70, 80 at different elevations to accommodate the cooking of other grains pre-cooked and dehydrated and/or original. Typically the amount of time required to cook the rice can be selected on the microwave when the microwave is initially started. When the time has elapsed, the bowl 10, 110 is ready for removal from the microwave oven and for enjoyment of the cooked rice (FIG. 8). Typically, enjoyment involves adding other ingredients and eating the rice and other ingredients directly from the bowl 10. As an alternative, the time could be broken into two subsets with an intermediate time between the two subsets of time taken to stir the rice R and water W within the reservoir 20.

This disclosure is provided to reveal a preferred embodiment of the invention and a best mode for practicing the invention. Having thus described the invention in this way, it should be apparent that various different modifications can be made to the preferred embodiment without departing from the scope and spirit of this disclosure. When structures are identified as a means to perform a function, the identification is intended to include all structures which can perform the function specified.

What is claimed is:

1. A microwave rice cooking bowl, comprising in combination:
a bowl containing a reservoir for holding rice and water during cooking;
said bowl including a floor defining a lower side of said reservoir;
said bowl including a pair of side walls extending up from said floor to a rim opposite said floor;
said bowl including a pair of end walls extending up from said floor to said rim opposite said floor;
said side walls and said end walls formed of a material which resists melting and decomposition when heated in a microwave oven;
a rice line formed in at least one of said walls, said rice line spaced from said floor and visible to a user;
a water line formed in at least one of said walls, said water line spaced from said floor and visible to the user; and
said water line located above said rice line and below said rim of said bowl.

2. The bowl of claim 1 wherein said pair of side walls and said pair of end walls together completely surround lateral sides of said reservoir.

3. The bowl of claim 2 wherein said side walls and said end walls come together at lateral curves therebetween, said lateral curves providing a smooth transition between edges of each of said end walls and edges of each of said side walls.

4. The bowl of claim 3 wherein lower curves are interposed between said floor and each of said walls, providing a gradual transition between said floor and each of said walls.

5. The bowl of claim 4 wherein said rice line is located at an upper end of said lower curves.

6. The bowl of claim 1 wherein said rice line is located spaced above said floor by a distance greater than a distance between said rice line and said water line.

7. The bowl of claim 1 wherein said water line is located closer to said floor than to said rim.

8. The bowl of claim 7 wherein said rice line is between about 0.5 inches and about 0.75 inches from said floor.

9. The bowl of claim 8 wherein said water line is located between about 0.625 inches and about 0.875 inches from said floor.

10. The bowl of claim 9 wherein said rim is located at least as great as 1.50 inches from said floor.

11. The bowl of claim 1 wherein each of said end walls includes a handle extending laterally therefrom at portions of said end walls opposite said floor.

12. The bowl of claim 11 wherein each said handle includes an arch on an upper surface thereof.

13. The bowl of claim 1 wherein said side walls extend up from said floor with a taper away from each other as said side walls extend up from said floor, said taper measuring at least 5° away from perpendicular to said floor.

14. The bowl of claim 1 wherein said water line is formed by printing a visible line on at least one of said walls.

15. A rice cooking bowl, comprising in combination:
a bowl containing a reservoir for holding rice and water during cooking;
said bowl including a floor defining a lower side of said reservoir;
said bowl including at least one wall extending up from said floor to a rim opposite said floor;
a rice line formed in at least one of said walls, said rice line spaced from said floor and visible to a user;
a water line formed in at least one of said walls, said water line spaced from said floor and visible to the user; and
said water line located above said rice line and below said rim of said bowl.

16. The rice cooking bowl of claim 15 wherein said side walls extend up from said floor with a taper away from each other as said side walls extend up from said floor, said taper measuring at least 5° away from perpendicular to said floor.

17. The rice cooking bowl of claim 15 wherein said water line is located closer to said floor than to said rim.

18. The rice cooking bowl of claim 17 wherein said bowl includes a pair of side walls extending up from said floor to a rim opposite said floor;
said bowl including a pair of end walls extending up from said floor to said rim opposite said floor;
wherein said pair of side walls and said pair of end walls together completely surround lateral sides of said reservoir.;
wherein said side walls and said end walls come together at lateral curves therebetween, said lateral curves providing a smooth transition between edges of each of said end walls and edges of each of said side walls; and
wherein lower curves are interposed between said floor and each of said walls, providing a gradual transition between said floor and each of said walls.

19. A method for cooking rice, comprising in combination:
providing a bowl containing a reservoir for holding rice and water during cooking, the bowl including a floor defining a lower side of the reservoir, a rice line visible on at least one of the walls, the rice line spaced from the floor and visible to a user, a water line visible in at least one of the walls, the water line spaced from the floor and visible to a user, and the water line located above the rice line and below the rim of the bowl;
filling the reservoir up to the rice line with rice;
filling the reservoir with water up to the water line; and
heating the bowl including the rice and the water until the rice cooks and absorbs substantially all of the water within the reservoir.

20. The method of claim 19 including the further steps of:
adding non-rice ingredients to the reservoir after said heating step and eating the rice and non-rice ingredients directly from the bowl.
